(19) United States
(12) Patent Application Publication
(10) Pub. No.: US 2008/0162190 A1
(43) Pub. Date: Jul. 3, 2008

(54) System and Method for a Patient-Specific and Clinician-Specific Pay-For-Performance Management System

(75) Inventor: Ahmed Ghouri, San Diego, CA (US)

Correspondence Address: DLA PIPER US LLP, 2000 UNIVERSITY AVENUE, E. PALO ALTO, CA, 94303-2248, US

(73) Assignee: SafeMed Inc., San Diego, CA (US)

(21) Appl. No.: 11/957,387

(22) Filed: Dec. 14, 2007

Related U.S. Application Data
(60) Provisional application No. 60/875,284, filed on Dec. 14, 2006.

(51) Int. Cl. G06Q 50/00; G06F 17/00

(52) U.S. Cl. 705/3; 705/2; 705/14

(57) ABSTRACT

A pay for performance system and method are described in which doctors of a patient are compensated based on the work performed for the patient using incentives that are insurer-specific, patient-specific, and visit-specific.

### PRIORITY CLAIM

This application claims priority under 35 USC 119(e) and 120 to U.S. Provisional Patent Application Ser. No. 60/875,284 filed on Dec. 14, 2006 and entitled “System and Method for a Patient-Specific and Clinician-Specific Pay-for-Performance Management System” which is incorporated herein by reference.

### FIELD

The invention relates generally to a system and method for managing health care information.

### BACKGROUND

Presently there is a large industry trend to reward physicians for quality of care, instead of just quantity of care and procedural interventions. This fundamental industry shift is occurring due to rapid exhaustion of financial resources to pay for an unlimited amount of care for every person. Furthermore, the present situation actually encourages over-treatment and excessive interventions because over-treatment and excessive interventions yield more revenue to healthcare providers and the institutions in which they work. As a result, insurers (health plans) and more broadly payers of healthcare, are rapidly adopting a reimbursement strategy known as “Pay for Performance”, abbreviated in the industry as “P4P”, in which payment to each physician is directly related to quality of care.

In the early phases of P4P programs, caregivers are not penalized for suboptimal care, but awarded additional payments when care is provided that adheres to documented quality metrics. Examples of P4P measures include annual eye examinations in diabetics, influenza vaccinations in the elderly, and annual screening mammograms for women above 40 years of age. Currently, most P4P programs are implemented by health maintenance organizations (HMOs) since each patient in the HMO has a primary care physician who can be reliably tracked as the “gatekeeper” of services and referrals, and thus provided incentives by the P4P system.

The fundamental limitation of contemporary P4P strategies is that there is no financial call to action in a specific patient visit because all rewards are generated from aggregated data. The rewards for complying with P4P measures are based on the percentage of eligible patients for whom the doctor adheres to “Best Practices” or predefined clinical guidelines, of which there are several thousand in contemporary medicine. For example, P4P payments are made on an annual, or at best quarterly basis, and reflect aggregated, macroscopic compliance to these selected clinical measures.

Practically speaking, this is a highly inefficient process: The majority of utilizers of healthcare are people with multiple chronic illnesses. These patients often see physicians for acute symptoms, and when they do, the generally time-overwhelmed doctor focuses on treatment of the present compliant, and commonly overlook other guidelines which apply to the care of the patient, yet were not the reason for the visit. For example, a patient with high cholesterol, high blood pressure, and heart disease may see a doctor with a cough and sputum production and be appropriately prescribed antibiotics. However, this patient may not have had his cholesterol evaluated in more than a year, may not have had an EKG in two years, or an eye exam to look for high blood pressure related changes in three years. During the present visit, perhaps 15 minute office visit, the physician is preoccupied with treatment of the patient's cough and difficulty breathing, and will commonly either forget or delay these necessary interventions. The physician may actually be keenly aware that he is being offered financial P4P incentives for adhering to these measures, yet it is too difficult for the doctor to remember all of them that might apply to a specific patient. Note that even if an electronic medical record exists, the act of browsing through every visit over the past 3 years to see which of these interventions has been instituted is also very time consuming.

Some advanced electronic medical decision support systems can prompt physicians to address such gaps in care. However, these prompts again lack sufficient, tangible financial impact, because the MD is compensated on an aggregated basis, and if deficient in a specific patient, may compensate for this scoring by being more aggressive on other patients in which the care might not be so acute or when the physician is not as pressed for time.

The current P4P systems also do not operate well in open access or preferred provider organization (PPO) environments in which a patient does not have a primary care physician and the patient often sees different specialists for each specific ailment. Therefore, in the PPO environment, it is difficult to provide incentives to each physician during each visit to perform certain care options.

### BRIEF DESCRIPTION OF THE DRAWINGS

FIG. 1 illustrates an example of a pay for performance method;

FIG. 2 illustrates an exemplary embodiment of a pay for performance system;

FIG. 3A illustrates an example of a user interface screen provided to a doctor by the pay for performance system shown in FIG. 2;

FIG. 3B illustrates an example of the user interface for a commercially available product/service that embodies the pay for performance system;

FIG. 4 shows an example of a justification for a specific guideline within the pay for performance system;

FIG. 5 illustrates an example of a portion a health record for a particular patient;

FIG. 6 illustrates an example of the meta-data communicated between the gateway and the rules matrix shown in FIG. 1; and

FIG. 7 illustrates a user interface for reason codes that are part of the pay for performance system.

### DETAILED DESCRIPTION OF ONE OR MORE EMBODIMENTS

A web-based, client/server software implementation of a pay for performance system and method are described below for illustration purposes. However, it will be appreciated, however, that the system and method is not limited to the specific implementation described below since the system and method can be implemented using other computer architectures, other links, etc.

The pay for performance system and method combine a patient health record with an analytical engine that contains healthplan defined reimbursement rules that are patient-specific. The patient health record does not need to exist locally with the physician, but can be a personal health record owned by the patient, a physician health record for that patient, an employer health record, or an insurer health record. Using rules that are predefined by a specific healthplan, the system create an actionable checklist for a specific physician and a specific patient, and at a specific moment in time (for a specific office visit). In the clinical checklist, each intervention is associated with a specific incentive, such as for example a financial reimbursement, to the doctor on that specific visit (a pay for performance incentive), should he/she act on the recommendations. Furthermore, the pay for performance incentives can be viewed as a running total for that physician across all patients, similar to an aggregated accounts receivable ledger.

In the past, systems attempted to reward physicians for withholding care, as was tried in the primary care gatekeeper model of many HMOs in the 1990s. In contrast, the present pay for performance system and method pays physicians to provide more care, but specifically for care or care options that lowers long-term costs through prevention or better management of disease. For example, a $150 influenza vaccination for a frail patient (preventive care option) can prevent a $50,000 hospital admission later. Without the present pay for performance system, only a fraction of the patients who are eligible to receive the preventive care option actually receive the preventive care option because the current systems do not provide the pay for performance incentives for each office visit to any doctor who sees the patient to encourage the preventive care option for the particular patient.

The pay for performance system and method encourages the immediate identification of treatable gaps in care. The pay for performance system and method also create a specific financial impetus at the Point of Care for action and may also contain rules which lead to decreased financial reward should these actions be delayed, leading to an even greater financial incentive for action.

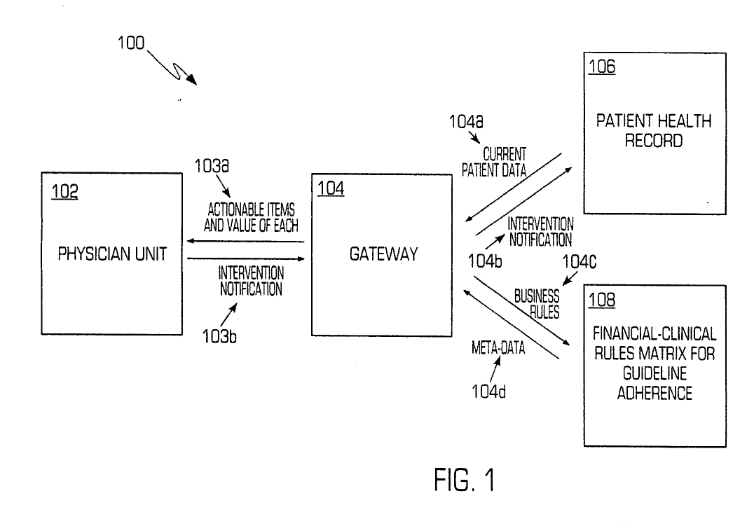

FIG. 1 illustrates an example of a pay for performance method 100 wherein a physician unit 102 (implemented in this example as a physician computer) interacts with a gateway 104 (implemented in this example as a processing unit based analytical processing engine and patient data gateway). The physician unit 102 may be any processing unit based device with sufficient processing power, memory, display capabilities and connectivity to perform the functions and operate as a pay for performance unit as described below. The pay for performance unit interacts with the gateway, displays a guideline list 103a (actionable items and the value of each item) for a particular patient on the pay for performance unit and allows the physician to indicate that the physician has provided a care option provided in the guideline list 103b (an intervention notification). The physician unit 102 may be, for example, a personal computer, a Windows CE based device, a smartphone, a PDA, a Palm operating system based device, a cellular phone, a mobile phone, a tablet computer, a laptop computer, a dumb computer terminal, etc. The gateway 104 may be implemented as one or more server computers that may host various software-based applications that perform the operations of the gateway as described below in more detail.

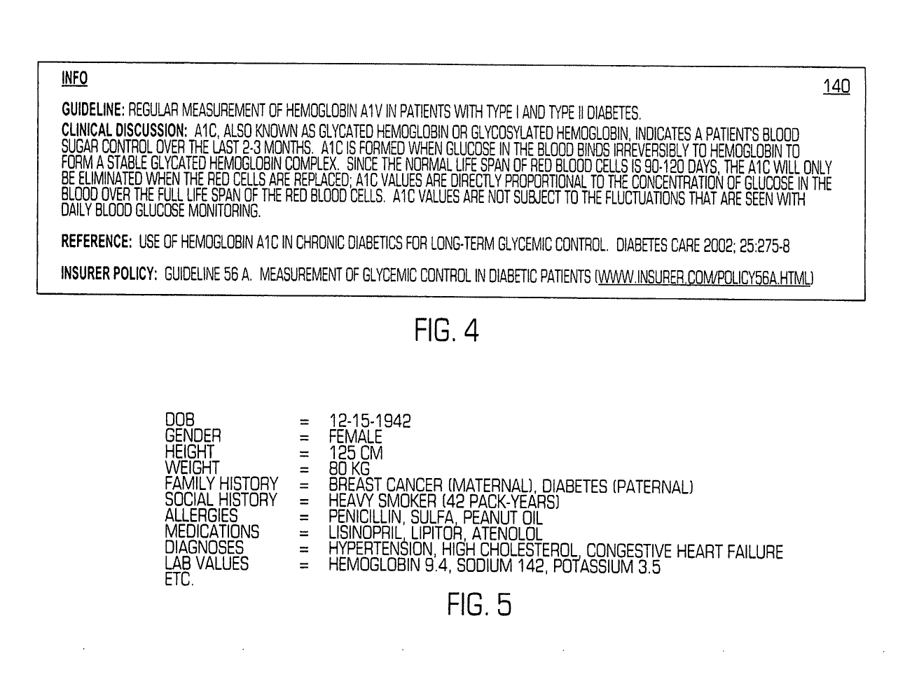

The gateway 104 may be coupled to a health record 106 and a rules matrix 108. The health record 106 may be, for example, an electronic health record for a patient wherein a plurality of health records may be stored in an electronic datastore such as a database maintained by a database server. The health record for each patient may include information about the patient, information about the one or more physicians that care for the patient and a medical history of the patient that, among other items, contains any diseases, medical conditions, risk factors, etc of the patient. An example of a portion of a health record of an exemplary patient is shown in FIG. 5. Each health record may be a patient owned heath record, a physician health record for that patient, an employer health record for the patient, a healthplan record for the patient or an insurer health record for the patient. In the method, the gateway 104 may retrieve current patient data from the health record (104a) and communicates any intervention notifications for the patient (based on the intervention notifications received by the gateway 104) to the health record (104b).

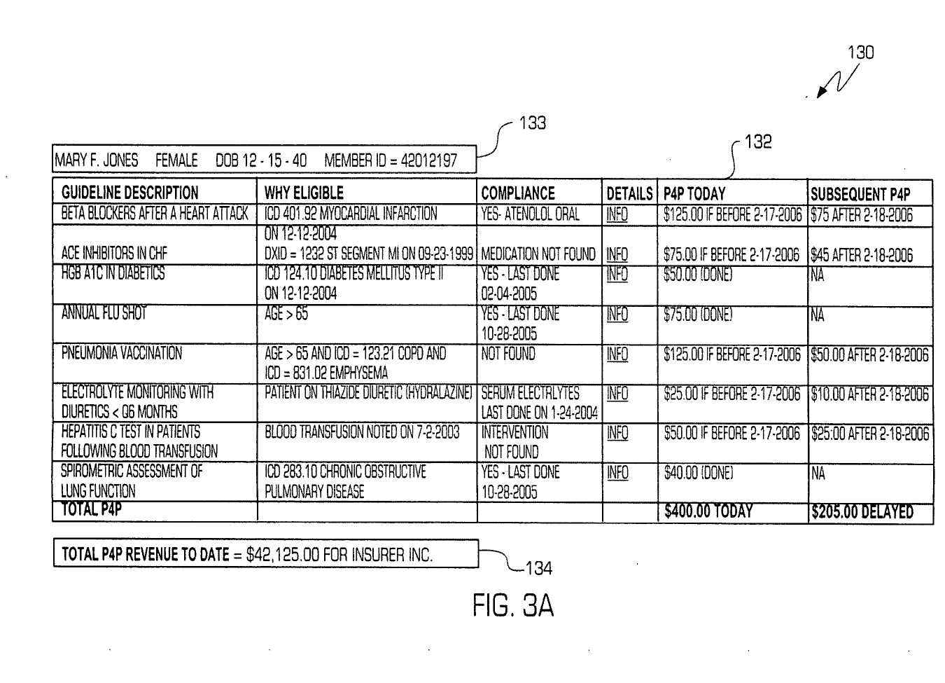

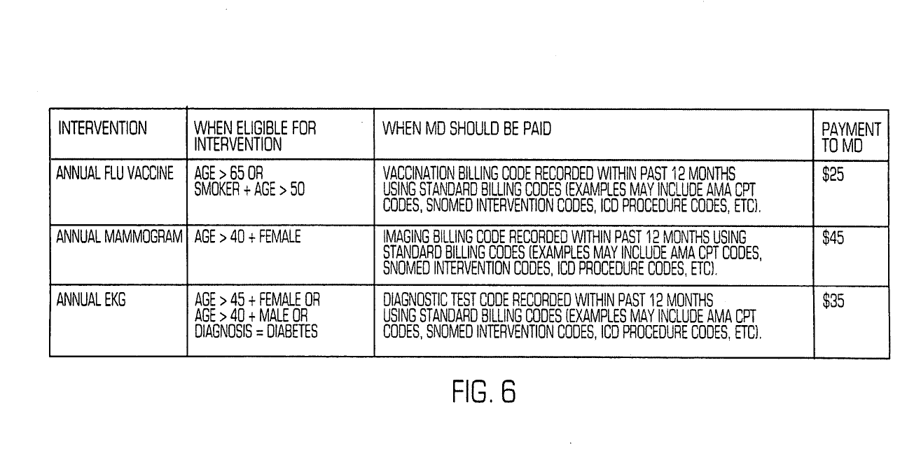

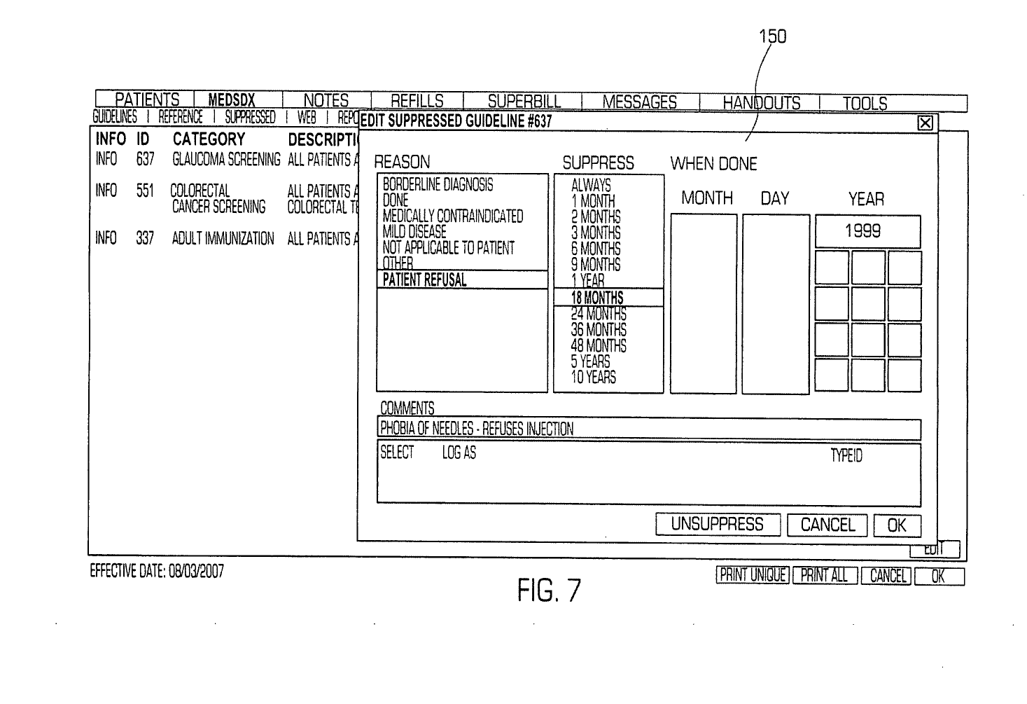

The rules matrix 108 may be, for example, an electronic guideline matrix that is stored in an electronic datastore such as a database maintained by a database server wherein the database and database server may be the same database and database server that stores the health record or it may be a different database and different database server. The rules matrix may contain a set of financial-clinical rules for guideline adherence wherein each rule has a guideline (a care option to be performed by a physician) and a pay for performance fee if that care option is performed by the physician. At that instant, each rule in the matrix may further comprise an eligibility standard to receive the care option and a detailed description of the care option and the eligibility standard. Each rule may optionally include a current P4P incentive as well as a subsequent P4P incentive for a particular care option wherein a physician may receive a smaller pay for performance incentive if the care option is performed after a predetermined time to incentive the performance of the care option during a current office visit. An example of a portion of the rules matrix shown in FIGS. 3A and 3B. The rules matrix may also contain and store a set of reasons codes (shown below in FIG. 7) that allow the physician to provide a reason that the particular care option has not been performed for a particular patient which is then stored in the health record 106 for the particular patient. The rules matrix 108 may be maintained by an employer, a healthplan provider and/or a health insurer. In the method, the gateway may retrieve the rules from the matrix (104c) in order to build a patient specific guideline list such as that shown in FIGS. 3A and 3B and the gateway may communicate meta-data (104d) back to the rules matrix. As example of the meta-data communicated from the gateway to the rules matrix is shown in FIG. 6.

Using the method shown in FIG. 1, the one or more physicians (a dermatologist, cardiologist, etc.) who care for a particular patient are provided incentives to perform particular care options for a particular patient (based on the patient specific guideline list) regardless of whether or not the patient has a primary care physician since the system provides an incentive to the first doctor for a patient (regardless of the doctor's specialty) who provides the particular care option to the patient. The care options may include preventive care options wherein those preventive care options are included in the patient specific guideline list due to a known condition, risk factor or disease of the particular patient. Thus, the system encourages preventive care options for a particular patient which may decrease later treatment costs of the particular patient.

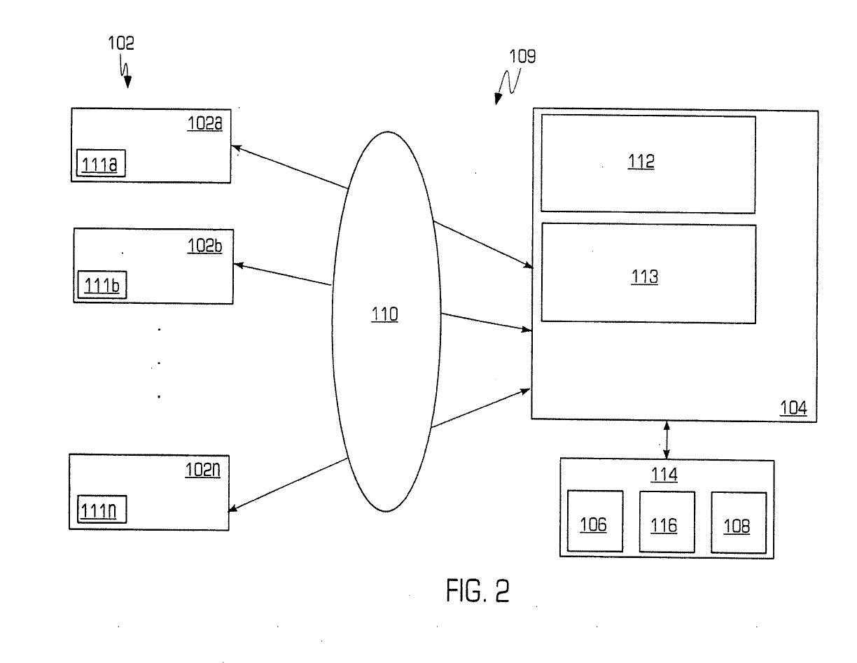

FIG. 2 illustrates an exemplary embodiment of a pay for performance system 109 that includes one or more physician units 102, such as physician units 102a, 102b, . . . , 102n) that are capable of establishing a session with the gateway 104 over a link 110. In the exemplary embodiment, the link 110 may be the Internet or World Wide Web wherein the physician unit and the gateway communicate using a known protocol, such as HTTP or HTTPS. However, the system is not limited to any particular link as the system may use any communications link, such as a landline or cellular link, or any network link, such as a local area network, wide area network, etc. Each physician unit 102 may include the pay for performance unit 111, such as pay for performance units 111a, 111b, . . . , 111n, that may be, in the exemplary web-based client/server embodiment, a pay for performance application that is implemented as a plurality of web pages that are displayed on a typical browser application executing on the physician unit wherein the physician receives data/information from the gateway, such as the patient specific guideline list, and intervention notifications are communicated back to the gateway when the physician performs a care option listed on the patient specific guideline list.

The gateway 104, in the exemplary embodiment may be implemented as one or more server computers that execute one or more pieces of software. In the web-based example, the gateway 104 may include a software-based web server 112, such as Apache web servers, executed by the processing unit(s) of the one or more server computer that establishes the communications session with each physician unit, generates the web-pages downloaded to each physician unit 102 and receives the data/information from each physician unit, such as the intervention notifications. The web server 112 can handle multiple simultaneous communication sessions with a plurality of physician units. The gateway 104 may also include a pay for performance unit 113, implemented as a piece of software executed by the processing unit(s) of the one or more server computer(s) that interacts with the rules matrix 108, generates a patient specific guideline list for a specific patient at a specific time based on the rules matrix 108 and the health record 106 for the particular patient, receives the intervention notifications from a particular physician, and credits the particular physician with the appropriate pay for performance incentive (the today P4P incentive and/or the subsequent P4P incentive) for the care option associated with a particular intervention notification when the care option is provided.

The system 109 may further include a data store 114, implemented as one or more databases hosted on one or more database servers at one location or geographically distributed in the exemplary embodiment, that includes the health records 106 for a plurality of patients, the rules matrix 108 and a user portion 116 that may include various information about the users of the system. For example, the user portion may have a record associated with each physician that uses the system that includes the payment method for the particular physician such as an account number. The user portion may also have a record associated with each healthplan or insurer or employer that uses the pay for performance system. Thus, the pay for performance system and method may be used to administrate a plurality of pay for performance programs for a plurality of healthplans, insurers and/or employers.

FIG. 3A illustrates an example of a user interface screen 130 provided to a doctor by the pay for performance system shown in FIG. 2. In particular, when a physician logs into the system and retrieves the patient specific guideline list for a particular patient of the physician, such as Mary F. Jones, that physician is provided with the guideline list 132, information about the particular patient 133 (pulled from the health record) and, optionally, a total pay for performance revenue display 134 for the particular physician. The list 132 may include one or more guidelines wherein each guideline has a description of the care option, an eligibility standard, a compliance tracking portion, a details portions (showing details of the guideline, eligibility standard or compliance), a current P4P incentive and, optionally, a subsequent P4P incentive. The list 132 may optionally also include a total of the pay for performance incentives available for a current office visit (today) as well as the pay for performance incentive if the care options are performed after the current office visit.

FIG. 3B illustrates another example of the user interface screen 130 that is displayed to a doctor by the pay for performance system in FIG. 2. In this user interface example, the items in the list for a particular patient may be color coded for easy identification. For example, a completed intervention 135 may be color coded, such as green highlighting while high priority (clinical urgency) uncompleted items 136 are highlighted in red and a lower priority uncompleted item 137 may be highlighted in yellow. Thus, the user interface provides the doctor with a quick summary of the items for a particular patient and his/her status.

As shown in FIG. 3A, the incentives provided to the doctor may be a cash award that may be provided to the doctor quarterly, monthly, at year end or at any other time period. However, the system may also provide other incentives such as award points and the like so that the pay for performance system is not limited to any particular type of incentive.

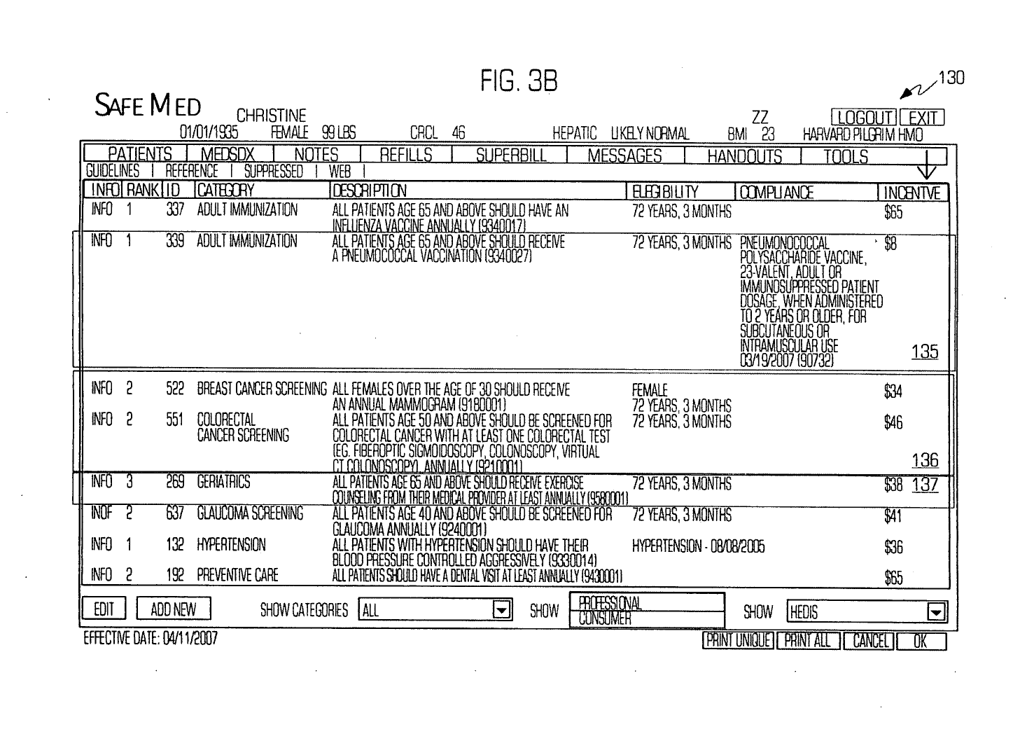

FIG. 4 shows an example of a justification for a specific guideline within the pay for performance system. In particular, a user interface 140 is displayed when the physician clicks on the info field in the list shown in FIG. 3. The user interface 140 may include further details of the guideline, a clinical discussion of the guideline, a reference for the guideline and a citation to the insurer policy.

FIG. 7 is a user interface 150 showing a reason code of the pay for performance system. This user interface is generated when a doctor clicks on the suppressed tab shown in FIG. 3B. The reason codes of the pay for performance system permit the doctor to indicate that the doctor attempted to provide the care that has the associated incentive, but was unable to do so for a variety of reasons. The pay for performance system wants to reward the doctor for attempting to administer the care to the patient even if, for example, the patient refuses the care. The user interface also allows the doctor to suppress (delay) a care item for different periods of time (always to 1 month as shown in the example) for various reasons including patient refusal as shown in FIG. 7.

While the foregoing has been with reference to a particular embodiment of the pay for performance system and method, it will be appreciated by those skilled in the art that changes in this embodiment may be made without departing from the principles and spirit of the pay for performance system and method, the scope of which is defined by the appended claims.

1. A system for pay for performance for care of a patient by one or more physician who care for the patient, the system comprising:
a health record containing information about a patient, one or more physicians associated with the patient and a medical history of the patient;
a pay for performance gateway having a rules matrix with a plurality of guidelines wherein each guideline associates a care option for care of a patient with a pay for performance incentive and generator unit that generates a patient specific guideline list for the one or more physicians associated with a particular patient based on the medical history of the particular patient and rules matrix; and
one or more physician units, wherein each physician unit has a pay for performance unit that is configured to, display the patient specific guideline list for the particular patient and permit the physician to indicate that the care option contained in the patient specific guideline list has been performed wherein the physician is incentivized to provide the care option based on the pay for performance incentive.

2. The system of claim 1, wherein the pay for performance gateway further comprises a payment unit wherein the physician that performed the care option in the patient specific guideline list is credited with the pay for performance incentive associated with the performed care option in the rules matrix.

3. The system of claim 1, wherein the rules matrix further comprises a set of reason codes wherein each reason code states a reason why a particular care option was not provided to a patient and wherein a particular reason code for a particular care option associated with a particular patient is stored in the health record associated with the particular patient.

4. The system of claim 1, wherein each physician unit further comprises a personal computer, a Windows CE based device, a smartphone, a PDA, a Palm operating system based device, a cellular phone, a mobile phone, a tablet computer, a laptop computer or a dumb computer terminal.

5. The system of claim 4, wherein the pay for performance gateway further comprises one or more server computers.

6. The system of claim 1 further comprising an electronic datastore that stores the health records for one or more patients.

7. The system of claim 6, wherein the electronic datastore further comprises a database maintained by a database server.

8. The system of claim 6, wherein each health record further comprises information about a patient, information about the one or more physicians that care for the patient and a medical history of the patient including any diseases, medical conditions, and risk factors of the patient.

9. The system of claim 1 further comprising an electronic datastore that stores the rules matrix.

10. The system of claim 9, wherein each guideline in the rules matrix further comprises a rule for a particular care option that includes an eligibility standard for the particular care option and a detailed description of the particular care option.

11. The system of claim 1, wherein the pay for performance incentive is a cash reward.

12. The system of claim 1, wherein the health record further comprises a patient owned health record, a physician owned health record, an employer owned health record, or an insurer owned health record.

13. A method for pay for performance for care of a patient by one or more physician who care for the patient in a system that has an electronic health record containing information about a patient, one or more physicians associated with the patient and a medical history of the patient, the method comprising:
associating, in a rules matrix in a pay for performance gateway having a plurality of guidelines, each guideline for a care option for care of a patient with a pay for performance incentive;
generating a patient specific guideline list for the one or more physicians associated with a particular patient based on the medical history of the particular patient and rules matrix;
displaying the patient specific guideline list for a physician who is currently caring for the specific patient; and
crediting the physician with the pay for performance incentive associated with a particular guideline in the patient specific guideline list when the physician performs the care option specified by the particular guideline.

14. The method of claim 13, wherein the rules matrix further comprises a set of reason codes wherein each reason code states a reason why a particular care option was not provided to a patient and wherein a particular reason code for a particular care option associated with a particular patient is stored in the electronic health record associated with the particular patient.

15. The method of claim 13 further comprising storing the electronic health records in an electronic datastore.

16. The method of claim 15, wherein each health record further comprises information about a patient, information about the one or more physicians that care for the patient and a medical history of the patient including any diseases, medical conditions and risk factors of the patient.

17. The method of claim 16 further comprising storing the rules matrix in the electronic datastore.

18. The method of claim 17, wherein each guideline in the rules matrix further comprises a rule for a particular care option that includes an eligibility standard for the particular care option and a detailed description of the particular care option.

19. The method of claim 13, wherein crediting the physician further comprises providing a cash incentive to the physician.

20. The method of claim 13, wherein the health record further comprises a patient owned health record, a physician owned health record, an employer owned health record or an insurer owned health record.
